(19) United States
(12) Patent Application Publication
(10) Pub. No.: US 2007/0147256 A1
(43) Pub. Date: Jun. 28, 2007

(54) TRANSPORT NETWORK NODE, FOR ADDITION OF TIMING DATA TO TRAFFIC ENGINEERING DATA

(75) Inventor: Antoine Pichot, Baulne En Brie (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/613,225

(22) Filed: Dec. 20, 2006

(30) Foreign Application Priority Data
Dec. 23, 2005 (FR) 0554067

(51) Int. Cl. H04L 12/26; H04J 3/22

(52) U.S. Cl. 370/238; 370/468

(57) ABSTRACT

Node (N1), of a transport network (R) incorporating a control plane using a routing protocol, including a traffic engineering database (BD1) and means of processing (MT) charged i) with exchanging with other nodes (N2-N6) of the network (R) routing messages incorporating traffic engineering data, so as to deed the database (BD1), ii) to add to some at least of the traffic engineering data which is contained in some at least of the routing messages timing data which is representative of its period of validity, and iii) to store in the traffic engineering database (BD1) timing data in association with the traffic engineering data to which it is added locally or in another node (N2-N6) of the network (R).

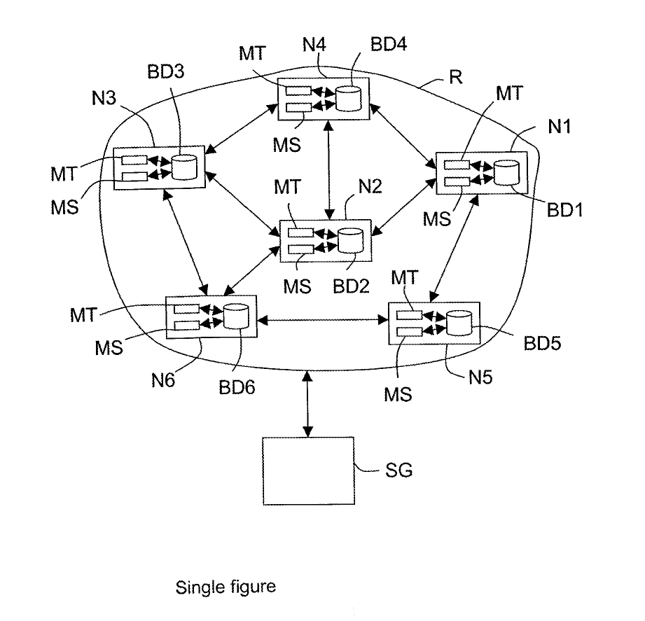

### BACKGROUND OF THE INVENTION

The invention relates to transport networks incorporating a control plane using a routing protocol, and more particularly the reservation of resources and/or computing routes (or connection paths) within such networks.

“Routing protocol” in this case means both routing protocols known as “link-state routing protocols”, such as OSPF (“Open Shortest Path First Protocol”), OSPF-TE (“OSPF-Traffic Engineering”) and IS-IS (“Intermediate System—Intermediate System) and routing protocols known as “distance-vector routing protocols”, such as BGP (“Border Gateway Protocol”) and RIP (Routing Information Protocol”).

Moreover, by “transport network incorporating a control plane using a routing protocol” is meant a transport network with a control plane, for example of the MPLS (for “Multi Protocol Label Switching”) or GMPLS (for “(Generalized) Multi Protocol Label Switching”) type.

It must be remembered that a transport network with a MPLS control plane is a network switching labels allocated, for example, to IP packets or ATM frames or Frame Relay, and having a MPLS control plane. Furthermore, a network with a GMPLS control plane is a network switching generalized labels associated to circuits, such as TDM networks (of the SONET/SDH, PDF, and G.709 types), or even associated with optical fibres, or again associated with input/output ports, and having a GMPLS control plane. Subsequently, these examples of networks with a distributed control plane have been designated by the expression (G)MPLS.

In the aforementioned networks, nodes responsible for routing data packets incorporate a traffic engineering database, with means of processing responsible for exchanging with other nodes, according to a chosen routing protocol (for example OSPF), routing messages containing traffic engineering data in order to feed their traffic engineering database, and means of signalling responsible for exchanging with other nodes according to a chosen signalling protocol (for example RSVP or RSVP-TE), signalling messages in order to allow reservation of connection path (or route) resources depending on the traffic engineering data stored in their traffic engineering database.

In this case, by “traffic engineering data” is meant all the data necessary for the reservation of resources in order to establish a connection passing via a path between a source node and a destination node, such as the topology of one part at least of a transport network, the respective states of the links set up between the nodes of this part of the transport network, and the current performance in the transport network part (such as the total resources, the resources used, transmission delays, error rates and the observed jitter).

This traffic engineering data is also used to determine connection paths (or routes), for example of the LSP (for “Label Switched Path”) or TE-LSP (“Traffic Engineering—LSP”) type, used by the nodes to make their resource reservations. These connection paths (or routes) are computed either locally by the nodes (i.e. in a distributed manner), or computed by a centralised network element. In the case of a network with a GMPLS control plane, the means of computing the connection paths are distributed in each of the network's nodes. Other means of computing connection paths are undergoing standardisation in the IETF standard accessible at the Internet address “draftietf-pce-architecture-02.txt”. These connection path computing elements, distributed or centralised, are called PCEs (for “Path Computation Elements”).

In current networks, connection paths and the reserving of connection path resources are computed from, in particular, current engineering data, i.e. representative of the current topology of the transport network, of the respective states of the links set up between the transport network nodes, and of the current performance of said transport network. They do not consider predicted information, such as the future network topology, the predicted network connectivity state and the predicted performance of the network, which would ease the task of the nodes.

### SUMMARY OF THE INVENTION

The aim of the invention is therefore to remedy the aforementioned disadvantage.

It proposes for this purpose a node for a transport network incorporating a control plane using a routing protocol, comprising a traffic engineering database and means of processing responsible for exchanging with other network nodes routing messages incorporating traffic engineering data, in order to feed the database.

This node is characterised by the fact that the means of processing are also responsible for attaching to some at least of the traffic engineering data which is contained in some at least of the routing messages timing data representative of the period during which it is valid, and for storing in the traffic engineering database timing data in association with the traffic engineering data to which it has been attached locally or in another network node.

The node according to the invention can incorporate other characteristics which may be taken separately or in combination, and in particular:
its means of processing can be responsible for attaching timing data to predicted traffic engineering data;
   its means of processing can receive some at least of the predicted traffic engineering data from a transport network management system;
   its means of processing can receive some at least of the predicted traffic engineering data in routing protocol messages;
   its means of processing can receive some at least of the predicted traffic engineering data from a transport network forecasting service system;
the timing data attached to the traffic engineering data can for example incorporate validity start and stop instants;
its means of processing can be responsible for attaching timing data in a routing message information sub-field;
it can include means of signalling responsible for exchanging with other network nodes signalling messages to allow reservation of connection path resources depending on the traffic engineering data an any attached timing data, stored in the traffic engineering database;
the traffic engineering data representative of the predicted performance can include information defined by reference to at least one class of predetermined traffic, in order to refine management of the quality of service.

The invention is particularly well suited, although not exclusively, to transport networks of the IP/(G)MPLS type. However, the invention is applied in general to any type of transport network incorporating a control plane using a routing protocol.

### BRIEF DESCRIPTION OF THE DRAWINGS

Other characteristics and advantages of the invention will appear on examination of the detailed description below, and from the attached drawing, on which the single FIGURE illustrates very schematically and functionally a part of a transport network including nodes according to the invention. The annexed drawing can serve not only to complement the invention, but also contribute to its definition, if need be.

### DETAILED DESCRIPTION OF THE INVENTION

The object of the invention is to facilitate the reservation of resources and the computing of connection paths (sometimes disjointed), within at least one transport network with a control plane using a routing protocol, with a view to future use.

In what follows, it is considered as one example (but not the only one) that the transport network is a network of the IP/GMPLS type. However, the invention is not limited to this type of network. It actually relates to all networks with a control plane using a routing protocol, and in particular MPLS or GMPLS networks.

Furthermore, as the network in this case is of the IP/GMPLS type, it uses a routing protocol of the OSPF-TE type and a signalling protocol of the RSVP or RSVP-TE type. However, the invention is not limited to these types of routing protocol and signalling protocol. It actually relates to other signalling protocols, such as OSPF, OSPF-TE and IS-IS and all routing protocols known as “remote vectors”, such as BGP (Border Gateway Patrol) and RIP (Routing Information Protocol).

An IP GMPLS R transport network incorporates very schematically nodes Ni interconnected by physical links, such as optical fibres, and generally coupled to a SG management system, such as a server, forming part of a network management system (or “NMS”). In the non-limiting FIGURE illustrated in the single FIGURE, the index i of the nodes Ni varies between 1 and 6 (N1 to N6) but in can take any value ≧two (2).

These nodes Ni are for example peripheral input/output routers or intermediate routers.

Each node Ni includes a traffic engineering database, hereafter referred to as database BDi, wherein is stored traffic engineering data, such as the topology of one part at least of its (transport) network R, the respective states of the links set up between the nodes Ni of this part of the network R, the resources already used in the part of the network R, as well as the risk estimates, if necessary and in particular. The databases BDi of the nodes Ni are fed with data and updated from a routing protocol, such as OSPF-TE (Open Shortest Path First Protocol—Traffic Engineering).

More precisely, each node Ni incorporates a processing module MT responsible for exchanging with other nodes Ni′ of the network R, according to the routing protocol, routing messages incorporating traffic engineering data, so as to feed the associated database BDi.

According to the invention, the processing module MT of each node Ni is responsible for attaching to some at least of the traffic engineering data, which it places in some at least of the routing messages addressed to other nodes Ni′, timing data representative of the period during which it is valid.

For example, the timing data which it attaches to the traffic engineering data are validity start and end instants.

Moreover, each processing module MT can for example attach timing data only to predicted traffic engineering data. The latter may have different sources.

Some at least of it may for example be communicated to the nodes Ni by a management system (for example SG) for the transport network R.

As a variant or in addition, some at least of the traffic engineering data can for example be created by the nodes Ni and communicated to other nodes Ni by means of routing protocol messages (in this case, OSPF-TE, but these could also be IS-IS-TE).

In another variant or in addition, some at least of the traffic engineering data can for example be communicated to the nodes Ni by a forecasting service system for the transport network R. This system (not shown) can for example be a server offering a service of the NWS (for “Network Weather System”, described specifically at the Internet address http://nws.cs.ucsb.edu/) type. This service is based on a distributed system of instantaneous data sensors, such as TCP/IP performance (bandwidth and transmission delay, in particular), available computing capacity (CPU), or available memory. It consists of setting over a given period the future operating (or performance) conditions for a network by means of a numeric model and the instantaneous data delivered by the sensors. The future performance thus determined and the associated network resources are transmitted, for example periodically.

Conventionally, it may for example be considered that traffic engineering data which is not associated to timing data is current data, i.e. representative of the network's links and its current topology.

The period of validity of a traffic engineering datum is set by the person or logical entity making the forecasts. Furthermore, the timing data which defines the periods of validity is preferentially transmitted with the forecast traffic engineering data.

Each processing module MT can for example attach the timing data in a status information sub-field of the routing messages link, dedicated to this purpose. For example, in the case of the OSPF-TE protocol, this sub-field can be of the TLV (“Type Length value”—type of information in question (in bits or bytes), and the value of the information in question).

According to the invention, each processing module MT is also responsible for storing in the database BDi of its node Ni, each corresponding to the other, firstly, the timing data which it attaches (locally) to the traffic engineering data and which it transmits in the routing messages to the other nodes Ni′ and, secondly, the timing data which is attached (or associated) to the traffic engineering data contained in the routing messages originating from the other nodes Ni′.

It may be considered that the current traffic engineering data should be stored in a first part of each database BDi, whereas the forecast traffic engineering data and the associated timing data should be stored in a second part of each database BDi. However, this is not obligatory, the important thing being to add the timing data in the form of validity start date and validity end date fields.

The invention provides each node Ni simultaneously with current traffic engineering data and valid traffic engineering data in the relatively near future. It can then compute the connection paths (link-disjoint if need be) for immediate use, and predict connection paths (link-disjoint if need be) for a future use if it is configured for this purpose (this is specifically the case when it has a path computing algorithm including the forecasting information).

A predicted connection path is computed from at least the predicted traffic engineering data which is representative of a predicted topology and a predicted connectivity status of a part at least of the transport network R and/or the predicted performance of a part at least of this transport network R.

In this case, “predicted performance” means information such as the maximum bandwidth of the links between nodes Ni, the available bandwidth for reservation over each link, the residual mean bandwidth, transmission delays, jitter, and data transmission error rates. According to one particular embodiment, the nodes Ni, are capable of managing the traffic according to a plurality of classes of service of predefined priority classes. To achieve this, the aforementioned traffic engineering data can be defined more finely, viz. for each link and for each class of traffic that must transit over this link.

Computing predicted routes or connection paths is similar to this, and familiar to the man skilled in the art, implemented to determine a route (or connection path) for immediate use. It will therefore not be repeated. However, it will be noted that it is possible to use algorithms computing more stable connection paths, given the timing data which is present on these links.

Each node Ni can also make connection path resource reservations by means of a signalling module MS coupled to its database BDi. It will be remembered that, when a signalling module MS has to make a reservation of resources between source and destination nodes, it must first of all have (a) connection path(s) (in this case, of the LSP-TE type). Consequently, in order that a signalling module MS should be capable of making a reservation of resources taking into account predicted traffic engineering data, it must have (a) predicted connection path(s). Once a signalling module MS is in possession of (a) connection path(s) (link-disjoint if necessary) between source and destination nodes, it can generate, addressed to the nodes Ni′ which define the computed connection path(s), the appropriate signalling messages (in the RSVP-TE example, this is the PATH message).

The nodes Ni according to the invention, and in particular their processing nodes MT and their databases BDi, as well as their signalling modules MS, if any, are preferentially produced as software (or computing) modules. However, they can also be produced as electronic circuits or as a combination of circuits and software.

The invention is not limited to the node production modes described above, simply for example, but it encompasses all the variants which the man skilled in the art might consider in the claims below.

1. Node (Ni) for a transport network (R) incorporating a control plane using a routing protocol, including a traffic engineering database and means of processing (MT) configured to receive from other nodes (Ni′) of said network (R) routing protocol messages incorporating traffic engineering data, so as to feed said traffic engineering database (BDi),
characterised by said means of processing (MT) being configured to attach timing data to predicted traffic engineering data representative of the predicted performance of at least one link of said network, said predicted performance including at least one item of information chosen in the group consisting of the maximum bandwidth of the link, the bandwidth available for reservation over the link and the remaining mean bandwidth over the link, said timing data being representative of a future period during which said traffic engineering data is valid,
being configured to send to other nodes (Ni′) of said network (R) routing protocol messages containing said traffic engineering data and said attached timing data,
and being configured to store in said traffic engineering database said timing data in association with the traffic engineering data to which it was added by said means of processing.

2. Node according to claim 1, characterised by said means of processing (MT) being configured to receive from another node of said network (R) a routing protocol message containing timing data and traffic engineering data representative of the predicted performance of at least one link of said network, said predicted performance including at least one item of information chosen in the group consisting of the maximum bandwidth of the link, the mean bandwidth available for reservation over the link, and the remaining mean bandwidth over the link, said timing data being representative of a future period during which said traffic engineering data is valid, and said means of processing (MT) being configured so as to store in said traffic engineering database said timing data in association with said traffic engineering data.

3. Node according to claim 2, characterised by said means of processing (MT) being configured to receive some at least of said predicted traffic engineering data from a management system (SG) for said transport network (R).

4. Node according to claim 2, characterised by said means of processing (MT) being configured to receive some at least of said predicted traffic engineering data in messages from said routing protocol.

5. Node according to claim 2, characterised by said means of processing (MT) being configured to receive some at least of said predicted traffic engineering data from a predicted service system for said transport network (R).

6. Node according to claim 1, characterised by said timing data added to the traffic engineering data incorporating instants for the start and end of the validity.

7. Node according to claim 1, characterised by said means of processing (MT) being configured to add said timing data in an information sub-field in the routing protocol messages.

8. Node according to claim 1, characterised by the inclusion of means of signalling (MS) configured in order to exchange with other nodes (Ni′) of said network (R) signalling messages to allow reservation of connection path resources according to said traffic engineering data and said added timing data (if any), stored in said traffic engineering database (BDi).

9. Node according to claim 1, characterised by said traffic engineering data representative of predicted performance including data defined by reference to at least one given class of traffic.

10. Node according to claim 1, characterised in that it comprises a routing controller operating according to a link-state routing protocol chosen in a group including at least OSPF, OSPF-TE and IS-IS.

11. Node according to claim 1, characterised in that it comprises a routing controller operating according to a distance-vector routing protocol chosen in a group including at least BGP and RIP.
